(19) United States
(12) Patent Application Publication
(10) Pub. No.: US 2009/0081444 A1
(43) Pub. Date: Mar. 26, 2009

(54) Porous metal foam body

(76) Inventors: Markus Kattannek, Bochum (DE); Frank Prenger, Ratingen (DE); Jochen Spriestersbach, Duisburg (DE); Jurgen Wisniewski, Wesel (DE)

Correspondence Address: DARDI & ASSOCIATES, PLLC, 220 S. 6TH ST., SUITE 2000, U.S. BANK PLAZA, MINNEAPOLIS, MN, 55402, US

(21) Appl. No.: 11/921,141

(22) PCT Filed: May 30, 2006
(86) PCT No.: PCT/EP2006/062705

§ 371 Date: Nov. 27, 2007

(30) Foreign Application Priority Data
May 30, 2005 (EP) 05104614.2

(51) Int. Cl. B32B 3/00; C23C 4/08; B05D 1/18; B05D 5/00

(52) U.S. Cl. 428/306.6; 427/455; 427/456; 427/431; 427/433; 427/243

(57) ABSTRACT

A porous metal foam body obtainable by applying one or more layers of molten metal to an open-pore non-metallic substrate and allowing the molten metal to penetrate into the open pores of said non-metallic substrate to form a metal foam body whose metal component has at least partially penetrated into said open-pore non-metallic substrate. Said open-pore metal foam body is prepared by a process in which an open-pore non-metallic substrate is provided and coated with a molten metal, and the molten metal penetrates into the open pores of the open-pore non-metallic substrate.

The metal foam bodies can be employed in many fields of technology.

The present invention relates to a porous metal foam body, a process for the preparation of said metal foam body, and the use thereof.

Metal foams and their preparation are known. Thus, metal foams are prepared from a powder or by way of melt metallurgy by stirring in nucleating agents and gas.

DE 102 38 284 A1 describes a multistep process in which conductive particles are coated onto a non-conductive substrate having a foam structure (e.g., PU foam) as a basis for subsequent coating by electrodeposition, followed by performing an electrodeposition. Any material that has an open-pore foam structure can be used as the substrate. The substrate serves as a skeleton.

DE-A-100 13 378 describes porous ceramics filled with metal. Here, the whole porous cavity is filled with metal rather than just providing the surface of the pores with a metal layer.

Although DE-A-35 22 287 discloses an open-pore body for the filtering and/or catalytic treating of gases or liquids and processes for the preparation thereof, it points out like DE 102 38 284 that the pores of the non-metallic substrate must be prepared for electrodeposition by means of electrically conductive layers before the surface is metallized, for the metal layer according to the mentioned printed documents is applied by electrodeposition.

FR-A-2 679 925 also discloses the preparation of a porous metallic structure by a threefold metallization of the surface of a porous organic substrate.

The metal foams known from the prior art either have closed pores, so that not all surface regions of the metal foam are accessible, or in the case of open-pore metal foams, can be prepared only with high expenditure and have at least two metal layers.

It is an object of the present invention to provide a metal foam body, especially an open-pore metal foam body, that can be employed in a broad field of applications, and to provide a process for the preparation thereof that is simple and inexpensive.

This object is achieved by a porous metal foam body obtainable by applying molten metal to an open-pore non-metallic substrate and allowing the molten metal to penetrate into the open pores of said non-metallic substrate to form a metal foam body, wherein said molten metal is deposited on the surface of at least a partial population of the pores to obtain a metallized surface of the pores. In particular, the metallic component has at least partially penetrated said open-pore non-metallic substrate.

The porous metal foam body according to the invention has populations of pores in its lumen that are at least partially provided with a metallic surface. The population may also be established only partially in the form of a partial population of pores having metal on their surface, especially being located in the outer region of said non-metallic substrate. Thus, such a porous metal foam body has pores with a metallized surface in the outer region while there are no metallized pores in the inner region. Depending on the preparation method, there is no abrupt transition from metallized to non-metallized pore surfaces, but the abundance of the pores completely provided with a metallized surface gradually decreases towards the interior of the volume of said porous metal foam body. When an appropriate process control for the preparation of said porous metal foam body and an adapted thickness are used, almost all pores accessible to the molten metal can be successfully provided with a metallized surface.

Said applying of the molten metal can be effected by applying droplets of molten metal, e.g. by thermal spraying, by atomizing a molten metal, e.g. by rotational atomization of the molten metal, but also by dipping the substrate into an appropriate molten metal. According to the invention, iron, zinc, aluminum, copper, nickel, gold, silver, platinum, tin or their alloys can be used as the basis metals.

Also, several layers of the same or different metals may be applied to obtain a multilayered structure of the metal layer in the metal foam body of the invention. Especially zinc basis materials are suitable as the first layer on said non-metallic substrate because they ensure a good adhesion to both the substrate and the overlying metal layers.

For example, the metal foam body according to the invention has a porosity of from 5 ppi to 150 ppi (pores per inch), but other ranges may also be chosen.

The pores of the open-pore non-metallic substrates are formed and enclosed by “webs”. The surface or the webs of the substrate are covered by a layer, for example, by thermal spraying or atomization, e.g. air atomization. The layer thickness can be adjusted depending on the parameters of the application method for the metal droplets. The result is a foam body consisting of the sprayed material. Both open-pore foam bodies and open-pore foam bodies having a closed cover layer can be prepared. The foam body may consists of any material that can be processes, for example, by thermal spraying (iron, zinc, aluminum, copper, nickel, gold, silver, platinum, tin or their alloys). However, it is also possible, for example, to apply ceramic particles (tungsten carbide, aluminum oxide, silicon carbide), especially by thermal spraying.

The substrate can be provided completely with the material, but also in partial regions only.

The process according to the invention for the preparation of a metal foam body starts from an open-pore non-metallic substrate which is then coated with droplets of a molten metal, wherein the droplets of the molten metal at least partially penetrate into the open pores of the non-metallic substrate.

According to the invention, the application of the molten metal can be effected by thermal spraying, by atomizing a molten metal or by rotational atomization of a molten metal. The penetration of the molten metal can be promoted by measures known to the skilled person. These include, in particular, the variation of the size, shape and structure of the pores in the substrate, variation of the size, speed and temperature of the droplets, the spraying distance, the spraying time, the work angle between the substrate and the coating unit, multilayer spraying, generation of a negative pressure on the backside of the substrate, or a combination of such measures.

The open-pore non-metallic substrate that can be employed in the process according to the invention may be selected from porous inorganic or organic materials.

Inorganic materials that can be used are especially those selected from the group consisting of zeolites, silica gels, frits, ceramic materials, mineral fiber wool or combinations thereof.

The organic materials are selected, in particular, from the group consisting of open-pore foamed material consisting of plastics, such as foamed polyurethanes, polyesters, polyethers, foamed polystyrenes, open-pore natural or artificial sponges, wood wool or combinations thereof.

The droplets may consist, for example, of molten iron, zinc, aluminum, copper, nickel, gold, silver, platinum, tin or their alloys.

In one embodiment of the process according to the invention, the substrate can be removed thermally or chemically, for example, by burning it out in the case of organic substrates, after having been provided with the droplets of molten metal. The metal foam body according to the invention may be provided with two major surfaces, wherein one or both major surfaces are formed with a closed-pore or non-closed-pore layer of a material.

The latter case is a sandwich construction. For example, a polyurethane foam serving as the substrate can be provided on one side thereof with an open-pore layer of a zinc alloy, wherein the zinc alloy does not penetrate the substrate completely. The other side is provided with a multilayer structure consisting of a zinc layer and an overlying copper layer with penetration depths that also do not extend completely through the substrate. If an intermediate region in the polyurethane foam remains untreated, a three-component composite is obtained consisting of a zinc alloy metal foam body, the substrate polyurethane and a zinc/copper metal foam body. Depending on the design, the properties of the individual components (e.g., substrate/zinc layer/copper layer) can be adjusted in the finished sandwich. For example, a soft PU foam with a rigid “shell” of metal may be prepared. Thus, it becomes possible to adjust, for example, particular damping properties or flexural strengths while the surface is at the same time provided with an optical design.

For example, the metal foam body according to the invention can be employed in construction, especially for light-weight constructions, engine construction, automotive engineering, chemical industry, medical engineering, electrical engineering, i.e., basically in all fields where weight-saving but still solid or stiffened materials are important. Thus, the metal foam body according to the invention may be used, for example, for insulation boards, coverings, sound protection, building elements for electromagnetic shielding, vibration damping, crash absorbers, filters, catalysts, battery elements, semiconductors.

It is also possible to achieve a multilayer structure by spraying with different materials. The application of different materials in juxtaposition is also possible.

The shape of the foam body is typically defined by the substrate and thus can be prepared before spraying easily and true to shape (e.g., plates, balls, rods, sterically complex structures of substrate material; the substrate may also be preshaped prior to the coating and maintained in this state through the coating process).

The foam may also be used as a core for a composite material, for example, the metal foam can be designed as a composite material from a cover plate of light-weight metal bonded to a solder material by heating it to the soldering temperature and optionally inserted stiffening ribs.

The invention also relates to the use of the metal foam body according to the invention as a preliminary material for further coatings with metallic materials by electrodeposition methods, by deposition from the vapor or liquid phase, or by powder coating. In a preferred embodiment, the metal foam body according to the invention is used as a matrix for the filling with polymers or metal casting.

### EXAMPLES

### Example 1

A substrate in the form of a polyurethane foam having a thickness of 20 mm and a pores/inch of 10 ppi is coated with a layer of zinc by wire arc spraying. An open-pore metal foam body is obtained having a density of from 0.06 to 0.45 g/cm³ and a crushing strength of from 16 to 220 kPa.

### Example 2

A metal foam prepared according to Example 1 can be embedded as a matrix in the polymer or metal structure.

The open-pore metal foam can be filled with a liquid polymer to obtain a metal/polymer composite material with the combination of the materials. This can be employed, for example, as a crash absorber.

### Example 3

A substrate in the form of a polyurethane foam plate having a thickness of 20 mm and a pores/inch of 10 ppi is coated with a layer of zinc by wire arc spraying. An open-pore metal foam body is obtained having a density of from 0.06 to 0.45 g/cm³ and a crushing strength of from 16 to 220 kPa. A second layer of brass or copper is applied by wire arc spraying to form a plate having a high flexural strength and good sound absorption properties and an aesthetic surface appearance in a brass or copper design.

1-20. (canceled)

21. A porous metal foam body comprising
a metal foam body that comprises open-pore non-metallic substrate with at least a partial population of the open-pores comprising a metalized pore surface that comprises zinc, aluminum, tin or their alloys.

22. The metal foam body according to claim 21, wherein said metalized pore surface is located in an outer region and not in an inner region of said non-metallic substrate.

23. The metal foam body according to claim 21, wherein substantially all pores of said non-metallic substrate are pores that comprise the metalized pore surface.

24. The metal foam body according to claim 21 made by a process that comprises applying the zinc, aluminum, tin or their alloys as a molten metal by applying droplets of the molten metal by thermal spraying, by atomizing the molten metal, by rotational atomization of the molten metal or by dipping the open-pore non-metallic substrate into the molten metal.

25. The metal foam body according to claim 21 having a porosity of from 5 ppi to 150 ppi.

26. A process for the preparation of a metal foam body comprising coating an open-pore non-metallic substrate with one or more layers of molten zinc, aluminum, tin or their alloys, and the molten zinc, aluminum, tin or their alloys penetrates into the open pores of the open-pore non-metallic substrate.

27. The process according to claim 26, wherein said coating with the molten zinc, aluminum, tin or their alloys is effected by applying droplets of molten zinc, aluminum, tin or their alloys by thermal spraying, by atomizing a molten metal, by rotational atomization of a molten metal or by dipping the substrate into a molten metal.

28. The process according to claim 27, wherein said penetration by the droplets of molten zinc, aluminum, tin or their alloys is promoted by at least one method in the group consisting of varying the size, shape and structure of the pores in the substrate; varying the size, speed and temperature of the droplets; varying the spraying distance; varying the spraying time; varying the work angle between the substrate and the coating unit; multilayer spraying; and generation of a negative pressure on the backside of the substrate.

29. The process according to claim 26, wherein said open-pore non-metallic substrate is selected from porous inorganic or organic materials.

30. The process according to claim 29, wherein said porous inorganic materials are selected from the group consisting of zeolites, silica gels, frits, ceramic materials, mineral fiber wool and combinations thereof.

31. The process according to claim 29, wherein said organic materials comprise an open-pore foamed material in the group consisting of foamed polyurethanes, polyesters, polyethers, foamed polystyrenes, open-pore natural or artificial sponges, wood wool, fabrics, textiles and combinations thereof.

32. The process according to claim 27, wherein said molten zinc, aluminum, tin or their alloys have additions of ceramic particles.

33. The process according to claim 31, wherein said organic substrate is removed after having been coated with the molten zinc, aluminum, tin or their alloys.

34. A metal foam body made by the process according to claim 33.

35. The metal foam body according to claim 21 having two major surfaces, wherein one or both major surfaces comprise a closed-pore layer of a material.

36. The metal foam body according to claim 35 comprising a sandwich construction.

37. A device that comprises the metal foam body of claim 21 wherein the device is a member of the group consisting of components for insulation boards, coverings, sound protection, electromagnetic shielding, vibration damping, crash absorbers, filters, catalysts, battery elements and semiconductors.

38. A method of making a substrate material comprising: coating the metal foam body of claim 21 with metallic materials by electrodeposition, by deposition from vapor phase or liquid phase, or by deposition as a powder coating.

39. A device comprising the metal foam body of claim 21 serving as a matrix filled with polymers or metal casting.
